(19) United States
(12) Patent Application Publication
(10) Pub. No.: US 2026/0256182 A1
(43) Pub. Date: Sep. 3, 2026

(54) INDUSTRIAL LIQUID SPHERIFICATION DEVICE

(71) Applicant: Kimi RIDAURA AYATS, BLANES, GIRONA (ES)

(72) Inventor: Kimi RIDAURA AYATS, BLANES, GIRONA (ES)

(21) Appl. No.: 18/846,627

(22) PCT Filed: Sep. 7, 2022
(86) PCT No.: PCT/ES2022/070564

§ 371 Date: Sep. 12, 2024

(30) Foreign Application Priority Data
Mar. 17, 2022 (EP) 22382255.2

(51) Int. Cl. A23P 30/10; A23L 29/256

(52) U.S. Cl. CPC A23P 30/10; A23L 29/256

(57) ABSTRACT

An industrial liquid spherification device includes a container with a first liquid that reacts with a liquid to be spherified, forming a solid or gelatinous layer around the liquid to be spherified, a device for extracting the spheres from the container, a number of spoons joined in parallel to a motion transmission system, which rotates the spoons in a synchronous way with each other, and a dispenser of a second liquid for each spoon.

The present invention relates to a device to produce, at industrial scale, edible spheres from liquids. The device permits realising the procedure of reverse spherification.

The technique of spherification is basically used in the culinary field, although it is also used in cosmetics and pharmacy. It may be defined as the creation by means of a chemical reaction of a solid membrane containing a liquid within the same.

Spherification may be divided into two types, direct spherification and reverse spherification. In direct spherification, the sphere is produced by gelification from the exterior towards the interior, by virtue whereof the spheres formed may end up being exclusively constituted by gel. In reverse spherification, the process of gelification of the liquid is produced towards the exterior such that there is formed an exterior layer of gel occluding liquid within the interior thereof.

The formation of spheres is based on the contact between a calcium salt and alginate. In reverse spherification, the calcium salt is contained within the liquid to be spherified and the alginate in a solution wherein the said liquid is submerged with the calcium salt.

In spherifications of reverse type a starting liquid containing calcium ions (for example calcium chloride) typically reacts with a solution of alginate, forming a sphere.

Variables affecting the process and the final result are the thickness of the liquid and the pH of the mixture.

The majority of devices for spherification of known type are based upon the release of a drop of one of the two liquids to be spherified into a tank containing the other liquid to be spherified. This process presents the inconvenience of not being able to realise spherifications of greater size or, at least, not having a constant shape.

The document ES2676667B1, of the same inventor, reveals a device for spherification of a liquid having a first and a second tank for storage of a first and a second liquid having a dosing device of the first liquid and a tank of extraction of the spheres comprising a concave cavity fixed to a device of automatic extraction of the spheres, consisting in a worm. Into this concave cavity there is poured the liquid to be spherified. Once within the cavity the worm continues rotating in a manner such that this cavity rotates fixedly therewith, being submerged in the liquid to be reacted for the spherification contained in the second tank wherein there is also found the same worm. Once submerged in the liquid of the tank, the reaction starts and the screw continues rotating together with the cavity until the latter attains an angle whereat it no longer supports the sphere and the latter falls by precipitation to the bottom of the tank. Once at the bottom, the screw continues rotating, carrying the concave cavity to the starting point in order to collect more liquid to be spherified and, in addition and in a simultaneous manner, making the sphere roll out of the tank. This configuration is conceived for production of good quality and/or of greater size than those of dripping type, however of domestic scope, by virtue of the fact that the production quantity cannot be very high by virtue of the rate whereat the spherifications may be realised in an individual manner. In addition, some factors may be appreciated to be taken into account for the production. The rotation speed and the extraction speed of the spheres are necessarily linked, flowing wherefrom production is limited in a very evident manner. Furthermore, in order for it to function well, the worm and the tank containing it must be at an ascending angle with respect to the level of the liquid within the tank such that it covers the initial part whereat the sphere is realised but does not emerge at final part where the latter is finally extracted, this also delimiting in a clear manner the reaction time of the sphere.

An object of the present invention is to be capable of producing spherifications of liquids of greater size, of high quality on a large scale when necessary, that is to say being able to supply the need of production of spheres for industrial production.

In particular, the present invention discloses an industrial device for spherification of a liquid, comprising a tank of a second liquid which reacts with the liquid to be spherified forming a solid or gelatinous layer around the liquid to be spherified and a device to extract the spheres from the tank, a plurality of spoons, mounted in parallel to a system of transmission of movement making the spoons rotate in a mutually synchronous manner, and the device furthermore disposing of a plurality of dosers of liquid to be spherified, each doser being disposed in such manner as to permit dosing liquid to be spherified within the interior of a respective spoon.

This combination of elements permits that the process of spherification takes place in parallel, such that the production may be increased in a very significant manner. In addition, it also enables the proper formation of large spheres such as, for example, of olive or even egg yolk size. Furthermore, the speed of rotation of the spoons and that of extraction of the spheres are not closely related, nor is the angle between the second liquid and the tank thereof, by virtue whereof the path of extraction does not depend upon this variable, in this manner achieving a new variable in order to adjust the reaction time of the liquids, a very important factor for the proper creation of large spheres. This fact allows regulation of the production time in a much more efficient manner with respect to the reaction time necessary for the diverse spherifications to be produced.

The device wherein the second liquid is located may be a bucket or vessel of a sufficient extend to encompass the length of the plurality of spoons in parallel, a depth sufficient to permit the complete rotation of the spoons with respect to the axis of rotation thereof, and a length sufficient to house the device to extract the spheres from the tank.

In order to obtain the second liquid a solution may be realised adding the alginate required in a solvent and stirring to achieve good solution in a mixing tank separated in a manual manner, for example by operators.

Alternatively, said solution may be realised in a semi automatic manner, through manual addition of alginate and automated mixing by means of a stirring device or totally automatically, addition by means of doser of the alginate and stirring device. In the case of full automation the realisation of said solution directly in the tank of the second liquid may be contemplated.

In a similar manner, to obtain the liquid for spherification there may be added to a starting liquid an appropriate quantity of the different components of the solution thereof, for example calcium gluconate (to react with the alginate of the water and create the membrane), sodium citrate (to stabilise the pH), xanthan gum (to achieve the ideal thickness) for the solution and subsequently the stirring to achieve a good solution in a manual manner, for example by operatives, and this liquid being poured into a tank of the liquid to be spherified. In turn, this tank of the liquid to be spherified will discharge into a plurality of dosers in parallel, each spoon having the respective doser thereof.

In an alternative manner, the stirring may also be automated by means of a stirring device, for example a reactor with an impeller, the content of this reactor being subsequently transferred to the tank of the liquid to be spherified in order to be dosed upon each spoon, or even the content of this reactor being that which will be diversified upon each spoon in a direct manner.

The dosing may be realised, for example, by gravity in combination with a system evolves, or by pumping, such that they provide flow when required.

In a preferred embodiment, the spoons are located in parallel along a motorised shaft capable of rotating in both directions, controlling the speed and angle of rotation, being enabled to rotate more or less rapidly and stop or change the direction of rotation at the necessary points.

The rotation of the shaft may be provided by a programmable control unit.

Preferably, the programmable control unit is configured to follow a sequence of movements in an iterative manner. Said sequence of movements allows the creation of one sphere per spoon, realising as many spheres in one iteration as there are spoons affixed to the shaft, controlling a single motor making the shaft rotate.

The movements of said sequence promote the proper formation of the spheres. Starting from an initial position of horizontal repose of the spoons such that they are observed in profile and are located to the right of the shaft, said position of horizontal repose may be equated to a position of the spoons of angle 0°. The spoons subsequently rotate, the part thereof most distant from the shaft lowering, that is to say rotating in a clockwise direction, the concave part entering partially or totally into the second liquid. Preferably, said rotation is realised until attaining an angle of between −30° and −45°. Once sufficient liquid has entered within the spoon, a first change of direction of rotation is produced, the part most distant from the axis thereof rising, that is to say rotating in a counter clockwise direction, such that the liquid exits again, it passes through the initial horizontal position of angle 0°and continues rotating until attaining an angle, preferably between 45° and 90° depending on the speed of rotation, this permitting emptying the liquid from the spoons by gravity, pouring it once again within the vessel, until leaving a given quantity in the spoon. This small given quantity of liquid in the spoon is a factor to take into account having the objective of promoting the proper creation of the spheres, by virtue whereof it is sought that it always be the same, this being achieved through programming that the spoons stop always at the same angle in this step of the sequence, and obtaining an appropriate composition achieving, among other factors, that the density of the liquid to be spherified be greater than that of the second liquid. Having achieved this small quantity of second liquid remaining in the spoon, there is produced a second change in the direction of rotation, lowering the part most distant thereof from the shaft, that is to say rotating in the clockwise direction until the position of horizontal repose of angle 0°. It is in this second position of horizontal repose when the pouring of the liquid to be spherified upon the spoon is produced, that is to say within the interior of the cavity thereof, by means of a doser. Once the necessary quantity of liquid to be spherified for the sphere desired has been poured within each spoon, a reactivation of the rotation in the same direction as the previous movement is produced, that is to say it continues rotating in the clockwise direction, once again permitting the entry of the second liquid within the cavity of each spoon, the liquid to be spherified and the second liquid thus coming into contact for the first time in the process, a moment at which, both still within the concave space of the spoon, the film or solid or gelatinous layer starts to be created such that said membrane, assisted by the concave shape of the spoon, determines the initial shape of the sphere. Whilst the solid layer is being created and thickened, the shaft continues rotating in the same direction at a speed permitting that said solid layer be in a sufficiently developed state such that, having attained an angle whereat the spoons are no longer able to support the spheres, said spheres fall, through simple difference of densities between liquids, to the bottom of the vessel, where the sphere is collected by the conveyor belt and the solid layer will be thickening during the time wherein both liquids remain in contact. Once the spheres have been released, the spoons continue rotating in the same direction until attaining the position of horizontal repose of angle 0°, at which point the sequence ends and the following iteration starts.

The state of the spoon on receiving the liquid to be spherified as a factor to be taken into account by virtue of the fact that the walls are moistened by the second liquid and there is a quantity of this latter present in the cavity in order that the reaction start as soon as the liquid to be spherified is poured within the spoon and an initial gelatinous film is created, permits that there be good slippage between the sphere and the cavity and promotes the proper formation of the sphere.

In its turn, the distance between the level of the second liquid and the rim of the spoon in the position of horizontal repose is also a parameter in the process to be taken into account, by virtue of the fact that it will determine the moment whereat the second liquid enters into spoon and starts to react and form the solid layer on coming into contact with the liquid to be spherified, consequently, together with the speed of rotation of this step, this is becoming most significant at the start of the process of spherification by virtue of the fact that this determines to a great extent the shape which the spherified liquid will take, for which reason it is sought that this step be realised within the concave cavity of the spoon.

During the process of creation of the solid layer within the spoon, it is important to state that the gradual and constant rotation of the latter permits in turn a gradual and ideally constant rotation of the liquid upon itself through rolling against the interior wall of the spoon. This fact also assists in creating a better film around the liquid to be spherified and having a shape more rounded and as close as possible to a sphere.

In a preferred manner the tank has some vertical baffles or separators situated between spoons with the objective of rendering contact between spheres difficult once they have been freed within the tank of the second liquid, by virtue of the fact that contact between spheres in formation would result in an irreversible adhesion therebetween.

When the present invention refers to a liquid to be spherified, the latter may be any liquid. In the case wherein the liquid is food, this may be, for example, fruit juices, wine, alcoholic beverages, sauces, creams, etc.

Preferably, the second liquid is a homogenised mixture of alginate in water.

In a more preferred manner, the mixture has an appropriate concentration of alginate in conformity with the desired rapidity of the reaction with the liquid to be spherified.

In a preferred embodiment, the device to extract the spheres is a conveyor belt.

In an even more preferred embodiment, the device to extract spheres is a conveyor belt having vertical protrusions, perpendicular to the direction of conveyance of the belt, in order to provide better support to the spheres during their transfer and extraction.

In an alternative embodiment, the device to create and/or extract spheres is a plurality of inclined endless screws. In this case each inclined endless screw collects the capsule from a respective spoon. ES1243789U and EP3560584 reveal preferred endless screw realisations.

In a preferred embodiment the relative distance between the level of the second liquid and the rim of the spoons in the position of repose is adjusted by means of a sensor determining the level of the second liquid and, based thereupon, it is adjusted by adding the quantity of liquid necessary in order to attain the level desired, whether in a manual manner or automatically by means of a system of pumping or of valves.

In an alternative embodiment the adjustment of the distance between the level of the second liquid and the rim of the spoons may be realised by raising or lowering the shaft, whether in a manual or motorised manner, or also through a system of flotation upon the very second liquid, this not requiring a liquid height sensor.

In another alternative embodiment the shaft is substituted by a set of gears, driven by a principal gear driven by the motor controlled by the programmable control unit, in such manner that the spoons may describe a sequence of movements equivalent to that described also in a synchronous manner.

For the better comprehension hereof, in terms of an explanatory, but not limitative, example there are provided drawings of an example of embodiment of the present invention.

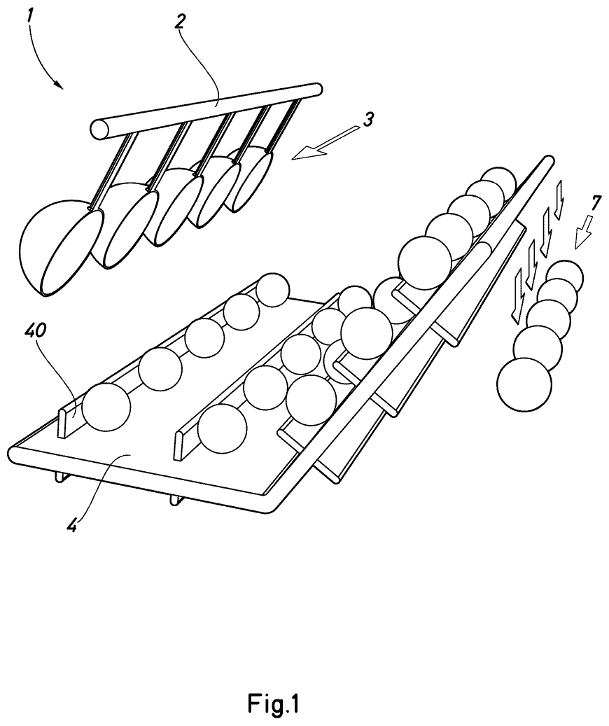

FIG. 1 shows a perspective view of the industrial device for spherification.

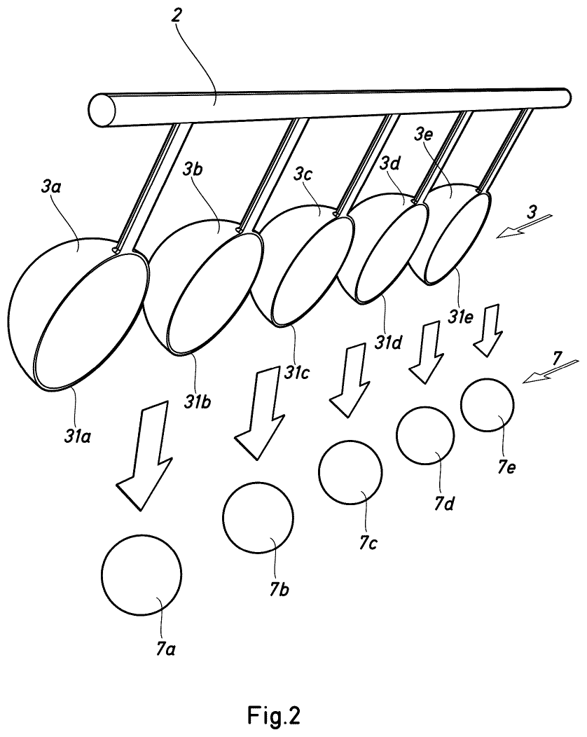

FIG. 2 shows a detailed perspective view of the plurality of spoons connected to the system of transmission of movements releasing the spheres of the liquid to be spherified already prepared.

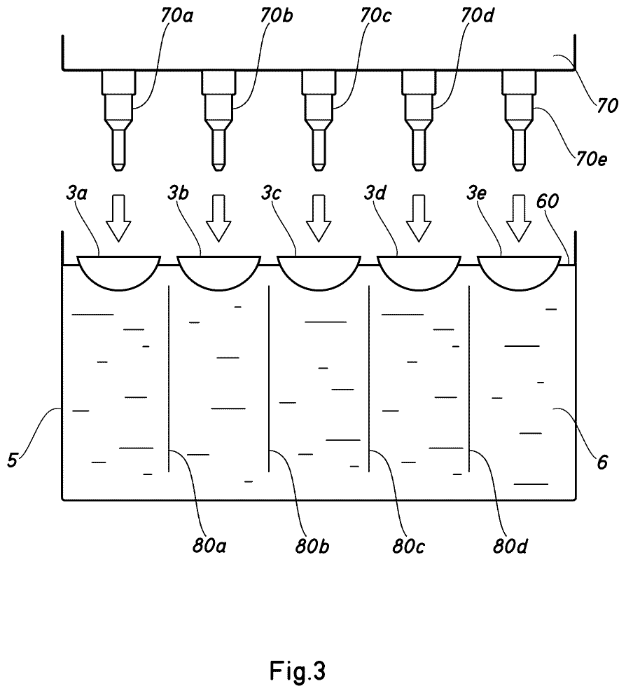

FIG. 3 shows a front elevation of the industrial device for spherification.

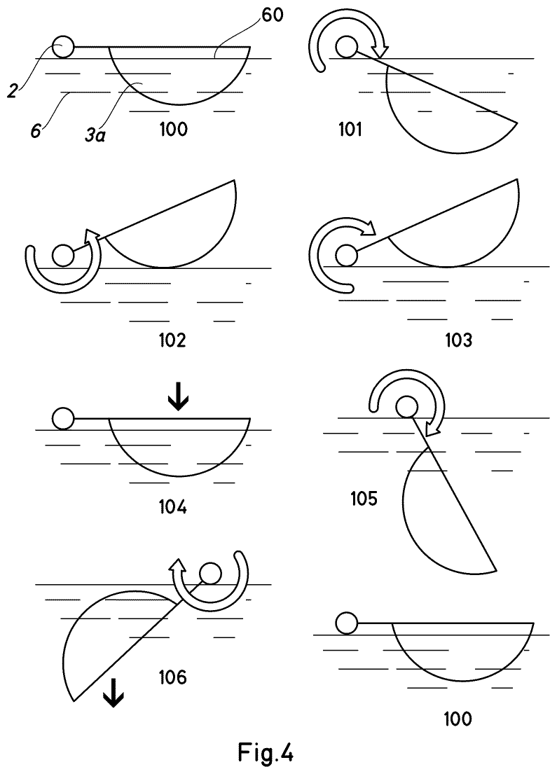

FIG. 4 shows a detailed profile view of the sequence of movements realised for the creation of the spheres.

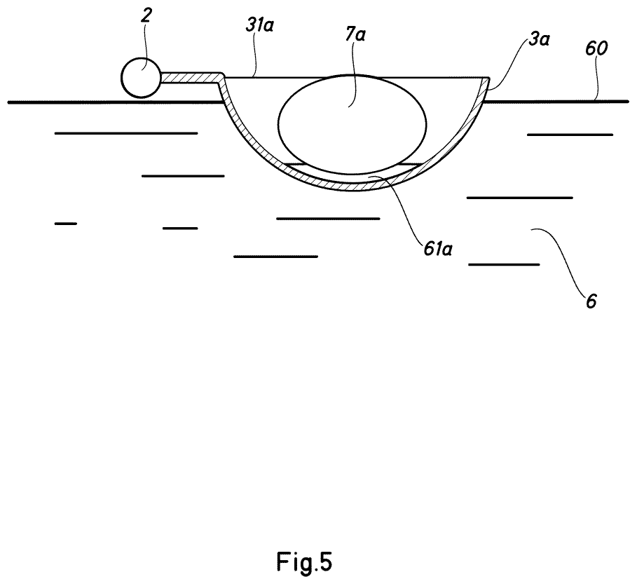

FIG. 5 shows a detailed profile view of the liquid to be spherified within the interior of the spoon.

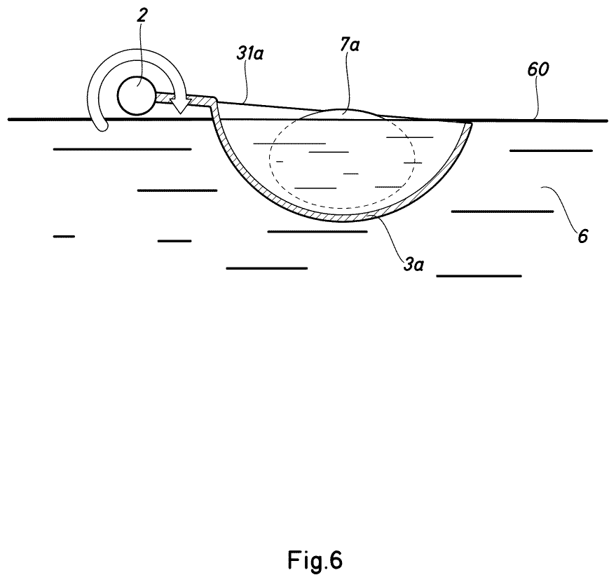

FIG. 6 shows a detailed profile view of the liquid to be spherified entering into contact with the second liquid within the interior of the spoon.

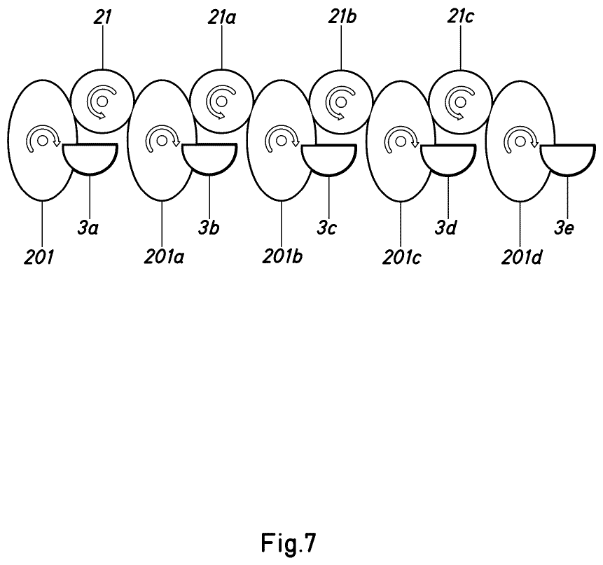

FIG. 7 shows a schematic view of an alternative system of transmission of movement.

FIG. 1 shows an embodiment of the industrial device for spherification 1 during the functioning thereof. In this figure neither the tank 5 of the second liquid 6 nor the second liquid 6 are shown having the objective of being able to better show the other elements comprising the device 1. The system of transmission of movement represented by a shaft 2 is shown whereunto there are affixed a plurality of spoons 3 in parallel dropping a plurality of spheres 7 upon the device to extract the spheres, represented by a conveyor belt 4, comprising some protuberances 40 perpendicular to the direction of movement of the conveyor belt 4 to extract the spheres having such a shape as to assist in impelling the plurality of spheres 7 in the desired direction for the extraction thereof.

FIG. 2 shows the same embodiment through a more detailed view of the shaft 2 and the plurality of spoons 3 in parallel wherein each individual spoon 3a, 3b, 3c, 3d, 3e is identified releasing the respective spheres thereof 7a, 7b, 7c, 7d, 7e created in the interior thereof and wherein there may also be observed the rims 31a, 31b, 31c, 31d and 31e of each spoon.

FIG. 3 shows the same embodiment having the plurality of spoons 3 and parallel surrounded by the other elements comprising the industrial device for spherification 1. In this figure the individual spoons 3a, 3b, 3c, 3d, and 3e are shown in a position of horizontal repose and the relative position thereof with respect to the second liquid 6, being partly submerged beneath the level 60 of the second liquid 6 contained within the tank 5 of the second liquid 6. It may be observed how each spoon 3a, 3b, 3c, 3d, and 3e has the respective doser thereof 70a, 70b, 70c, 70d and 70e of the liquid to be spherified, they being connected to a tank 70 of the liquid to be spherified. In FIG. 3 there are also shown the baffles 8a, 8b, 8c and 8d located between the spoons in a vertical manner, having the objective of rendering difficult the contact between spheres once having been released in the tank 5 of the second liquid.

FIG. 4 shows the sequence of movements realised by the spoons driven by the shaft 2 for the realisation of the spheres. Solely one spoon 3a is shown in this figure as an example of each sequence, however all the spoons would move in a synchronous manner following the same steps.

The steps in the sequence are identified by numbers. Taking into account that the sequence is iterative and follows from left to right and from top downwards, the order of the numbers is equivalent to the order of the steps in the sequence, the first step (upper left corner) and final step (lower right corner) being the same and therefore identified by means of the same number.

The sequence starts in the position of horizontal repose 100.

Starting from this position of horizontal repose 100, a rotation 101 of the spoons is produced, lowering a part distant from the axis of rotation 2, a concave part of the spoons entering partially or wholly into the second liquid 6. In this figure the level 60 of the second liquid 6 is represented by a line.

Subsequently there is produced a first change in the direction of rotation 102, the spoons emerging from the second liquid 6 passing through the initial horizontal position and rotating until an angle permitting emptying the second liquid by gravity and leaving a given quantity 61a (not observed in this figure) of the second liquid in the spoons.

Next, a second change of the direction of rotation 103 occurs until attaining a position of horizontal repose.

At this point, whilst the spoons are in horizontal repose position, is when the pouring of the liquid to be spherified 104 within each spoon is produced by means of the doser thereof.

Next, the reactivation of the rotation 105 is produced in the same direction as the previous movement, the spoons containing the liquid to be spherified becoming submerged again within the second liquid 6.

From this point there is a continuation of the rotation 106 in the same direction passing through a point whereat the spoons cease to support the spheres 7 (not shown in this figure) and these fall, through difference of densities, towards the bottom of the vessel until meeting the extraction system (not shown in this figure).

Said continuation of the rotation is maintained, the spoons emerging from the second liquid 6 until finally attaining the initial position of horizontal repose 100, wherefrom the following iteration of the sequence of movements starts.

FIG. 5 shows in detail the start of the creation of an individual sphere 7a within the interior of the spoon 3a affixed to the shaft 2, just when the liquid to be spherified has been poured within the spoon. It is shown how there is a small quantity 61a of second liquid 6 within the interior of the spoon, permitting the moistening of the interior walls of the spoon, and starts to react with the liquid to be spherified at the lower part creating an initial solid or gelatinous layer which collaborates not solely in the preparation of the sphere in the proper shape thereof, but also in an optimum emptying without residues within the spoon of liquid to be spherified. In FIG. 5 there is also shown how the spoon in the position thereof of horizontal repose, as in previous figures, is partially submerged in the second liquid 6, a good part of the external part of the cavity thereof beneath the level 60 of the second liquid 6, however with the rim 31a of the spoon being above, preventing the second liquid 6 entering within the interior of the cavity of the spoon and coming into contact with the liquid to be spherified earlier than desired.

FIG. 6 shows in detail how shortly after the reactivation of the rotation 105 being initiated, the rim 31a of the spoon 3a passes beneath the level 60 of the second liquid 6, now permitting the passage of the second liquid 6 into the interior of the cavity and, as a consequence, permitting the second liquid 6 and the liquid to be spherified come into contact and react to form the most external solid layer of the sphere 7a, which as time passes, whilst both liquids are in contact, will increase the thickness thereof towards the interior of the sphere. It is important to note that this step is crucial for the proper formation of the sphere by virtue of the fact that the shape of the cavity of the spoon will assist in creating the solid external layer of the sphere and the time wherein the two liquids are in contact within the spoon will determine how thick and strong this layer is and it being capable of maintaining this same shape on ceasing to be supported by the walls of the cavity.

FIG. 7 shows an alternative embodiment in schematic form of the device of transmission of movement, in this case represented by a principal gear 21 actuated by a motor (not shown) in turn acting upon a system of cams 201, 201a, 201b, 201c, 201d, 201e and of secondary gears 21a, 21b and 21c, the individual spoons 3a, 3b, 3c, 3d, and 3e being affixed to said cams such that the movements of the principal gear 21 are transmitted to each one of the spoons in a synchronous manner and the reproduction is achieved of the previously defined iterative sequence of steps for the production of spheres.

It must be emphasised that in the figures there are shown five spoons representing the plurality of spoons as a simple example, but that the number of spoons in parallel may be at least two and, as a consequence, the respective components associated with each one would vary in a manner according to the number of spoons in parallel.

Although the invention has been presented and described making reference to embodiments of the same, it shall be understood that the latter are not limitative of the invention by virtue whereof there may be multiple variables of constructive or other details which will be obvious for those skilled in the art subsequent to interpreting the material revealed in the present description, claims and drawings. In this manner all the variants and equivalents shall be included within the scope of the present invention if they can be considered to be comprised within the broadest scope of the following claims.

1. A industrial device for spherification of a first liquid comprising:
a tank for a second liquid which reacts with the first liquid to be spherified, which forms a solid or gelatinous layer around the first liquid to be spherified; and
a device to extract the spheres from the tank, wherein the device comprises a plurality of spoons mounted in parallel to a system of transmission of movement making the plurality of spoons rotate in a mutually synchronous manner, and wherein the device configured to dispose a plurality of dosers of the first liquid to be spherified, wherein each of the plurality of dosers is configured to dose the first liquid to be spherified within an interior of each of the plurality of spoons.

2. The industrial device according to claim 1, wherein the system of transmission of movement is actuated by a single motor.

3. The industrial device according to claim 2, wherein said single motor rotates in both directions.

4. The industrial device according to claim 3, wherein a speed of the rotation of said single motor is controlled.

5. The industrial device according to claim 1, wherein said single motor is programmable.

6. The industrial device according to claim 1, wherein the system of the transmission of the movement comprises a shaft.

7. The industrial device according to claim 1, wherein the system of the transmission of the movement is a system of gears driven from a principal gear.

8. The industrial device according to claim 1, wherein the device to extract the spheres from the tank is a conveyor belt.

9. The industrial device according to claim 1, wherein the device to extract spheres from the tank is a conveyor belt having an ascending inclination.

10. The industrial device according to claim 8, wherein the conveyor belt comprises protuberances in order to impel the sphere.

11. The industrial device according to claim 1, further comprising: a dosing pump of the first liquid to be spherified.

12. The industrial device according to claim 1, further comprising a sensor to detect a level of the second liquid.

13. The industrial device according to claim 1, further comprising an automatic system of maintenance of a level of the second liquid in the tank.

14. The industrial device according to claim 1, wherein each of the plurality of spoons has a doser of the second liquid having an objective of moistening interior walls of each of the plurality of spoons and dosing a quantity of the second liquid prior to the pouring of the first liquid to be spherified.

15. A method for spherification of the first liquid using the industrial device according to claim 1, comprising an iterative sequence of rotational movements of the system of transmission of movement of the following sequential steps:
rotating the spoons, starting from a position of horizontal repose, lowering a part distant from the axis of rotation and a concave part of the spoons entering partially or totally into the second liquid
changing the direction of the rotation, the spoons emerging from the liquid, passing through the initial horizontal position and rotating until an angle permitting emptying the second liquid by gravity, and leaving a given quantity of the second liquid in the spoon
again changing of the direction of the rotation until achieving position of horizontal repose
pouring a second liquid within the spoon by means of the doser thereof
reactivating the rotation in the same direction as the previous movement, the spoon containing the liquid to be spherified being submerged again within the second liquid
continuing the rotation in the same direction until reaching a point whereat the spoon ceases to support the sphere and that falls, through difference of densities, towards the bottom of the vessel until meeting the system of extraction
once the sphere has been released, maintaining the same direction of the rotation until the position of initial horizontal repose, wherefrom a next iteration starts.
